(19) United States
(12) Patent Application Publication
(10) Pub. No.: US 2004/0024723 A1
(43) Pub. Date: Feb. 5, 2004

(54) Computer network-managing knowledge system permitting of a simultaneous, parallel and independent assessment approach and device for several people

(76) Inventor: Chio-Shya Chen, Taipei (TW)

Correspondence Address: RABIN & BERDO, P.C., Suite 500, 1101 14th Street, Washington, DC, 20005, US

(21) Appl. No.: 10/208,741

(22) Filed: Aug. 1, 2002

(51) Int. Cl. G06F 17/00

(52) U.S. Cl. 706/50

(57) ABSTRACT

A computer network-managing knowledge system permitting of a simultaneous, parallel and independent assessment approach and device for several people is the management and application system for knowledge and information installed on the communication network platform. It collects and manages professional knowledge and business information from different fields efficiently; then, it establishes Knowledge Base and Model Base with the computer's powerful storage and calculation ability. Furthermore, it sets up the collecting network for knowledge content and the analysis model as well as the application channel for Knowledge Base and Model Base by means of the spaceless and timeless characteristics of Internet. The main benefit of the present invention aims at accumulating, sharing and distributing knowledge, shorting the time of learning, enhancing the enterprise's competitiveness, providing a decision-making model on the basis of knowledge and information and, finally, promoting the quality of decisions.

### BACKGROUND OF THE INVENTION

1. Field of the Invention

This present invention is a computer network-managing knowledge system permitting of a simultaneous, parallel and independent assessment approach and device for several people, especially those that offer a decision-making model on the basis of knowledge and information through the accumulation, share and extension of knowledge, which achieves the goal of “universal” decision-making, enhances the quality of decision, shortens the learning curve through the experience accumulated in the Knowledge Base, and in turn enhances the enterprise's extension.

2. DESCRIPTION OF THE PRIOR ART

Traditional decision-making is based on the cognition of the decision-maker that exists inside each specialist's memory. When it comes to the decision-making that requires the judgment from more than one person, conferencing is the most common way through it. There might be documental information for reference; however, such information is usually unorganized collected temporarily by the preparatory organization. Such an approach has the following disadvantages:

1. The restriction on people's memory that disappears easily; difficulty in passing down the experience of the decision-makers.

2. Inconvenience of passing down the documental information; restriction on the capacity passed down; inability in updating the latest data immediately.

3. To attend the conference, each participant must spare the same time and show up at the same location (for video conferences, participants do not have to show up at the same place); therefore limited time usually restricts the participants to think over carefully.

4. Discussing through conferences might cause “Flying-geese Effect”; that is, the majority follows the one who speaks most, who speaks powerfully or who speaks first; or the one who is superior or the authority, blocking the way of brainstorming.

5. Constrained basis of the referral data; the difficulty in enhancing the quality of the decision for complicated problems.

This shows the traditional approach still has many disadvantages and needs more improvement.

In view of the disadvantages above, the inventor of the present invention devoted to the innovation and improvement. After years of research, the inventor came out the computer network-managing knowledge system permitting of a simultaneous, parallel and independent assessment approach and device for several people.

### SUMMARY OF THE INVENTION

The objective of this present invention aims at providing a computer network-managing knowledge system permitting of a simultaneous, parallel and independent assessment approach and device for several people, in which it provides a decision-making model on the basis of knowledge and information through the accumulation, sharing and expansion of knowledge. With the present invention, the “Flying-geese Effect” in conferences is eliminated. Moreover, proposing within the specified time allows people to think over carefully, achieves truly “universal” decision-making and enhances the quality of decision. Participants involved in the decision-making distribute all over the world, unrestricted from the time and the location or space, making the decision-making more efficient. In the meantime, the experience accumulated in Knowledge Base shortens the time of learning and promotes the enterprise's competitiveness.

Another objective of this present invention aims at providing a computer network-managing knowledge system permitting of a simultaneous, parallel and independent assessment approach and device for several people, in which it accumulates the decision-makers' experience and accesses to each kind of academic theory and the specialists' suggestions through systematic collection, analysis, arrangement and application of relative information, which in turn extends the referral basis.

Still another objective of this present invention aims at providing a computer network-managing knowledge system permitting of a simultaneous, parallel and independent assessment approach and device for several people, in which each kind of experience of the decision-makers is accumulated and preserved as the enterprise's intellectual capital, for the sake of protecting the enterprise's competitiveness from the influence of personnel variation.

To achieve the above objectives of this present invention, it is necessary to establish a set of mechanism that collects, concretizes and literalizes the content of abstract knowledge, subjective knowledge, human consciousness, management decision and business information systematically into Knowledge Base and Model Base. With Knowledge Base and Model Base located on the computer network platform applied by several people simultaneously, parallel and independently, it helps assess the value of the issue, estimate the quality of the product, gather the common consensus and fulfill the goals of the decisions, free from the restriction of the assessors' time and location. By means of this parallel operation, all coordinative assessors would be able to comment independently, unbridled from others' influence.

When a problem in need of a solution occurs, it issues the application for support to Knowledge Base and Model Base through the computer network platform. After obtaining relevant referral knowledge and the analysis model, people can establish the knowledge application project for decision-making and return all system resources after resolution. In other words, by accessing adequate resources from Knowledge Base and Model Base, people are able to express opinions simultaneously, equally and independently and obtain quantified results through the application of analysis model.

### BRIEF DESCRIPTION OF THE DRAWINGS

The drawings disclose an illustrative embodiment of the present invention which serves to exemplify the various advantages and objects hereof, and are as follows:

FIG. 1 is the system structural diagram for the computer network-managing knowledge system permitting of a simultaneous, parallel and independent assessment approach and device for several people for the present invention.

FIG. 2 is the structural diagram about the Knowledge Collection System of the computer network-managing knowledge system permitting of a simultaneous, parallel and independent assessment approach and device for several people for the present invention.

FIG. 3 is the structural diagram about the Knowledge Supply System of the computer network-managing knowledge system permitting of a simultaneous, parallel and independent assessment approach and device for several people for the present invention.

FIG. 4 is the structural diagram about the Knowledge Application System of computer network-managing knowledge system permitting of a simultaneous, parallel and independent assessment approach and device for several people for the present invention.

FIG. 5 is the flowchart diagram about establishing Knowledge Base of the computer network-managing knowledge system permitting of a simultaneous, parallel and independent assessment approach and device for several people for the present invention.

FIG. 6 is the flowchart diagram about establishing Model Base of the computer network-managing knowledge system permitting of a simultaneous, parallel and independent assessment approach and device for several people for the present invention.

FIG. 7 is the first application flowchart diagram about the assessment of the Knowledge Application System in the computer network-managing knowledge system permitting of a simultaneous, parallel and independent assessment approach and device for several people for the present invention.

FIG. 8 is the second application flowchart diagram about the assessment of the Knowledge Application System in the computer network-managing knowledge system permitting of a simultaneous, parallel and independent assessment approach and device for several people for the present invention.

FIG. 9 is the third application flowchart diagram about the assessment of the Knowledge Application System in the computer network-managing knowledge system permitting of a simultaneous, parallel and independent assessment approach and device for several people for the present invention.

FIG. 10 is the structural diagram about the Knowledge Case Assessment Inventory System in the computer network-managing knowledge system permitting of a simultaneous, parallel and independent assessment approach and device for several people for the present invention.

### DETAILED DESCRIPTION OF THE PREFERRED EMBODIMENT

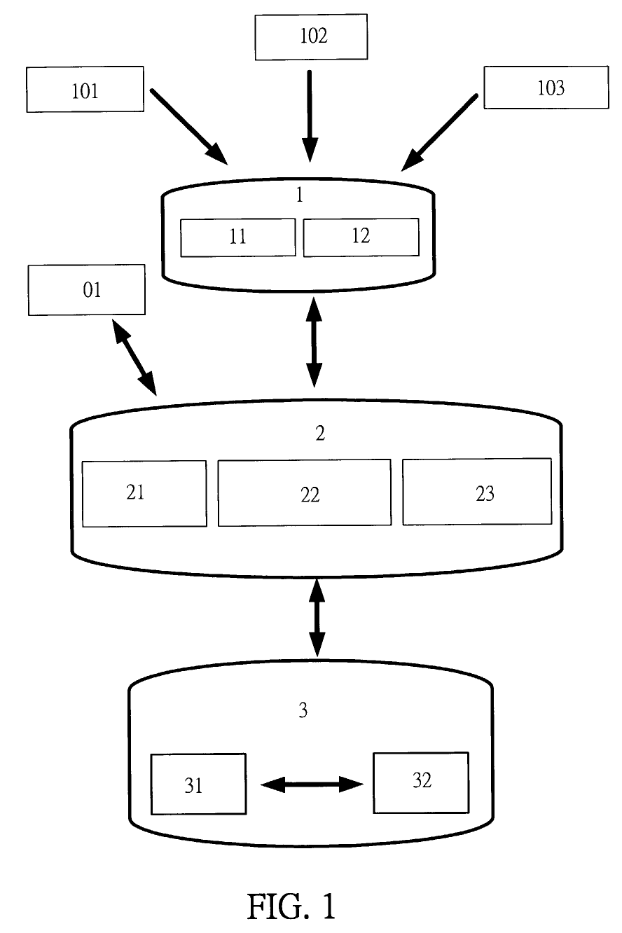

Please refer to FIG. 1. The present invention provides a computer network-managing knowledge system permitting of a simultaneous, parallel and independent assessment approach and device for several people that consists of Knowledge Collection System 1, Knowledge Supply System 2 and Knowledge Application System 3. By collecting knowledge through wired or wireless Internet for management, transmission and application, it provides a simultaneous, parallel and independent assessment approach and device for several people in the assessment for the value of the issue and the quality of the product, congeals people's common consensus, and achieves the goals of decisions without being restricted by the time and space of the assessors. By means of this parallel operation, all coordinative assessors would be able to comment independently, free from others' influence. In other words, it symbolizes and literalizes the knowledge content of abstract knowledge, subjective knowledge, human consciousness and management strategy or operating data and then stores them systematically in Knowledge Base and Model Base. When a problem in need of a solution occurs, it withdraws adequate resources from Knowledge Base and Model Base for people to express opinions simultaneously, equally and independently and obtains quantified results through the application of analysis model. In which,

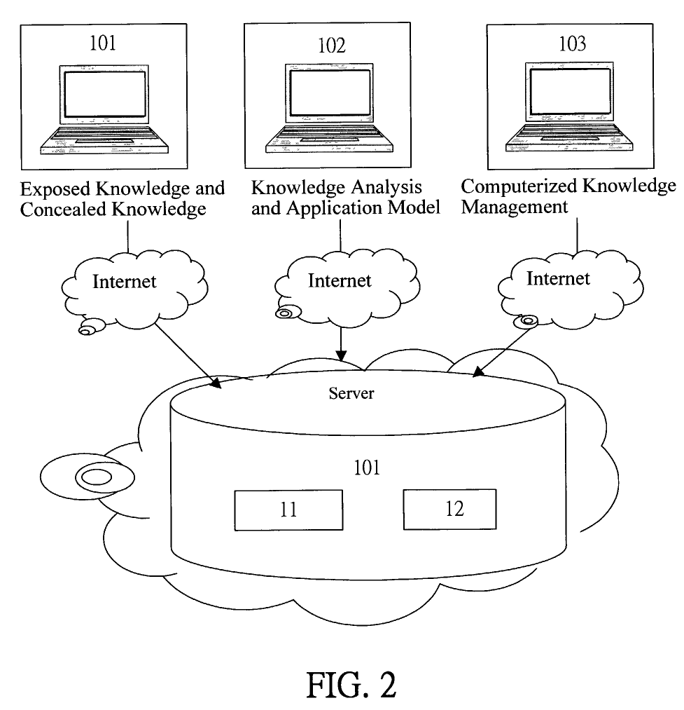

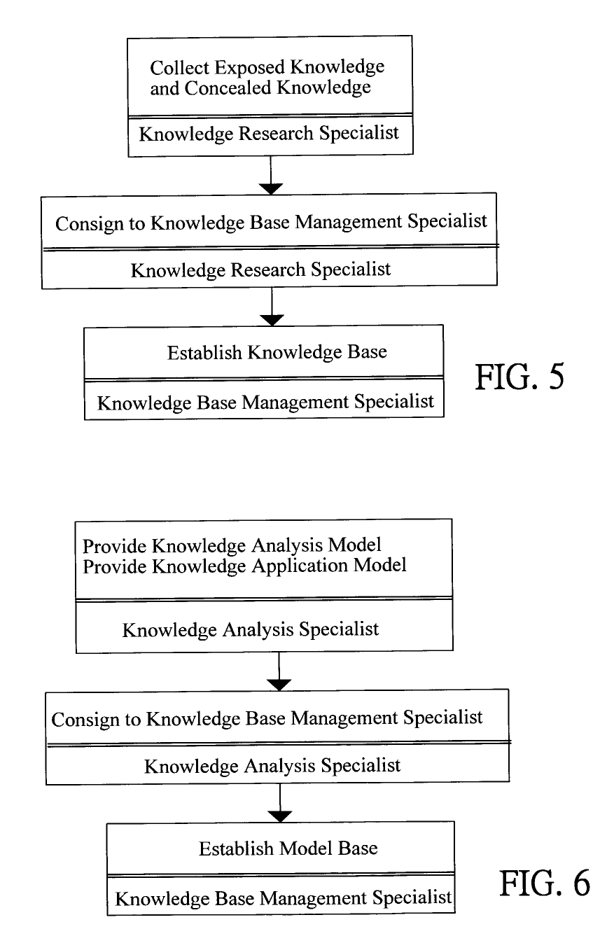

1. A Knowledge Collection System 1 and the Server connected to the system (Please refer to FIG. 2, FIG. 5 and FIG. 6.) Knowledge Collection System 1 includes:

A. One or more Knowledge Research Specialist 101, each one has a particular networked computer ID, password and authority, responsible for collecting exposed knowledge and exploiting concealed knowledge and then handing over to Knowledge Management Specialist 103 for establishing Knowledge Base 11. Knowledge Research Specialist 101 could be full-time or part-time, or even the additional duty on the employees. The source of the exposed and concealed knowledge could be professional knowledge, business information, and experience or research results inside the enterprise or adequate quotations from the publicized essay, report, academic theories.

B. One or more Knowledge Base Management Specialist 103, each one, equipped with the knowledge management and network computerization skills, has a particular networked computer ID, password and authority. Knowledge Base Management Specialists 103 are responsible for the designing of Knowledge Base 11 (where knowledge is stored up) and Model Base 12 (where knowledge is analyzed and applied) that are managed with computerization, so as to store the exposed knowledge and concealed knowledge collected and exploited by Knowledge Research Specialist 101 for the application of Knowledge Analysis Specialist 102. Knowledge Base Management Specialist 103 could be full-time or part-time.

The Server includes:

A. KBMS—Knowledge Base Management System, in charge of managing the structure and access to Knowledge Base; MBMS—Model Base Management System, in charge of managing the structure and access to Model Base. This management system provides Multiple Tier Access Method.

B. The media space for storing up knowledge and models. The storage of the knowledge and models follows the regulations of the KBMS and MBMS mentioned above.

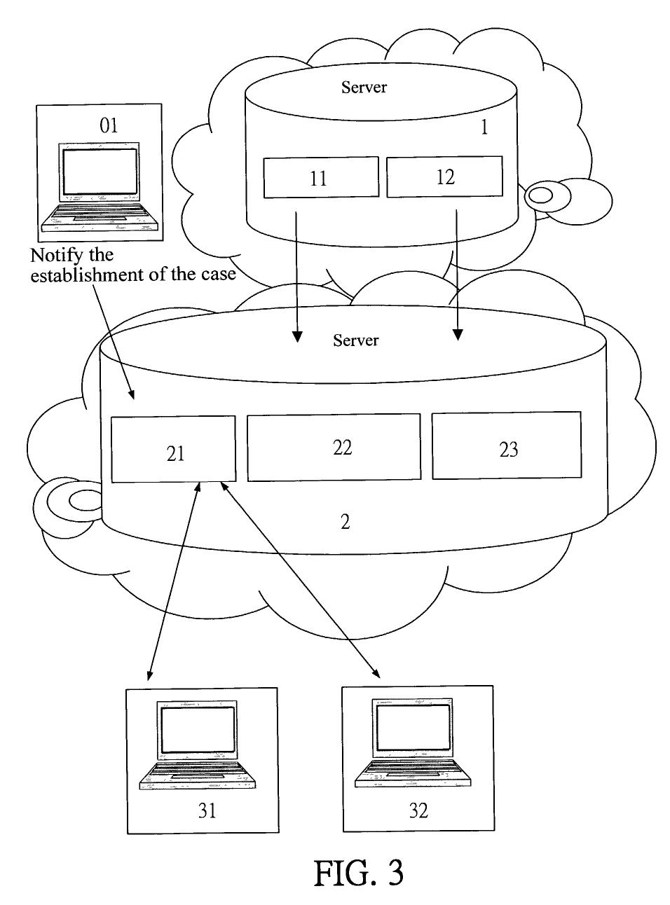

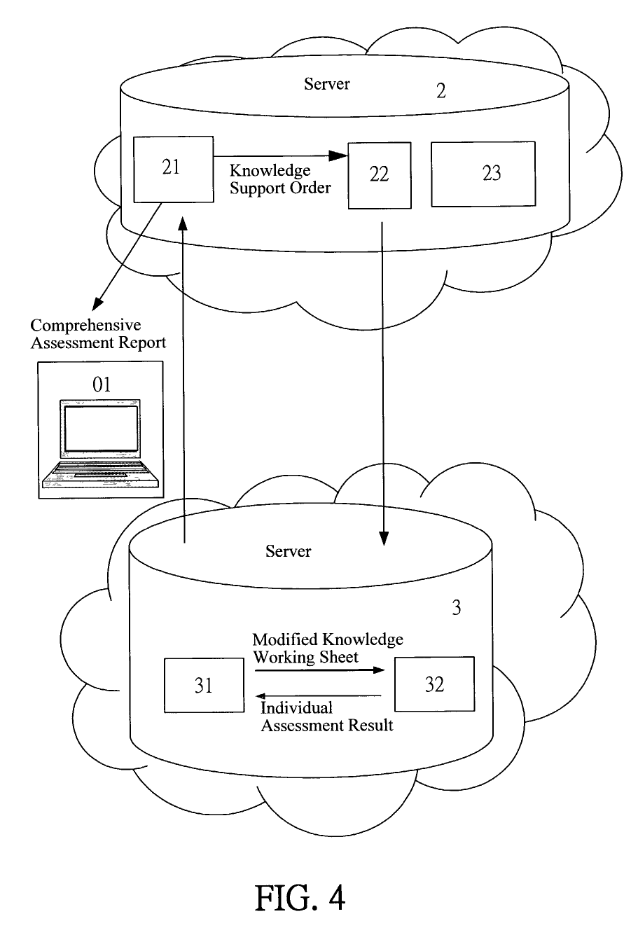

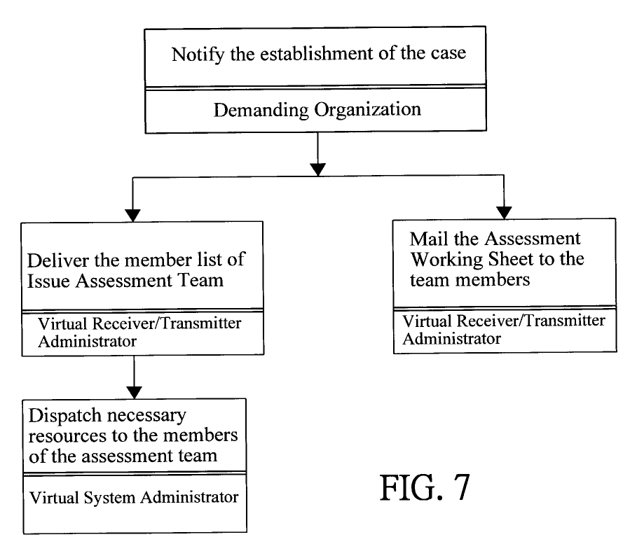

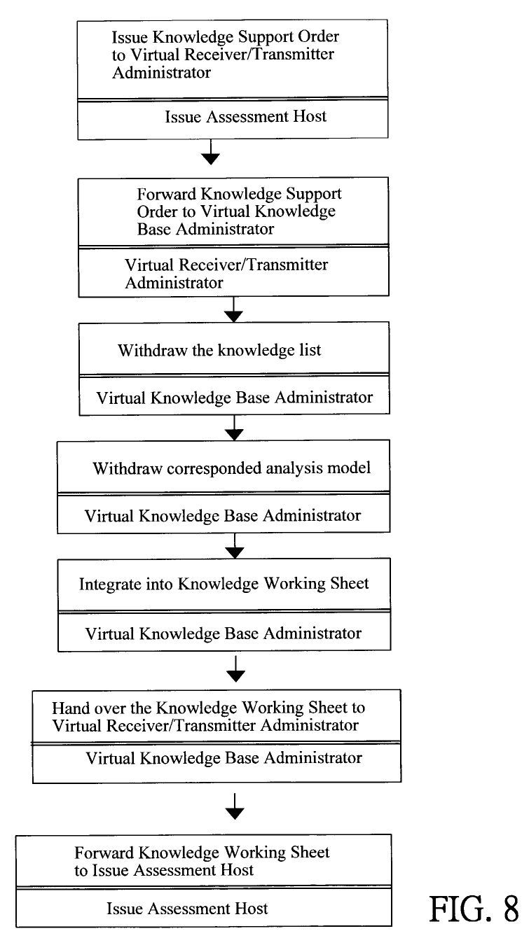

2. A Knowledge Supply System 2 and the Server connected to the system (please refer to FIG. 3, FIG. 4, FIG. 7 and FIG. 8.) Knowledge Supply System 2 includes:

A. A Virtual Receiver Transmitter Administrator 21 in charge of notifying the occurrence of the case, receiving (uploads) the order requiring for knowledge support and delivering Knowledge Working Sheet accurately conformed to the order, giving permission to handle several cases simultaneously, receiving (uploading) several orders, delivering (downloading) several Knowledge Working Sheet corresponded to each order together and making correct response to the IP of each order.

B. A Virtual Knowledge Base Administrator 22, responsible for the arrangement, classification and establishment of Knowledge Base 11 and Model Base 12 in accordance with the design of Knowledge Base Management Specialist 103 and for the expansion, reduction and modification of the authority for the content of Knowledge Base 11 and Model Base 12. On receiving the Knowledge Support Order from Virtual Receiver Transmitter Administrator 21, Virtual Knowledge Base Administrator 22 should withdraw the corresponded analysis model from Model Base 12 to form the Knowledge Working Sheet and hand it over to Virtual Receiver Transmitter Administrator 21 who then forwards it to Issue Assessment Host 31.

The Server includes:

A. A Virtual System Administrator 23, in charge of the IDs, password, authority and corresponded IPs of the users accessing to Knowledge Base 11 and Model Base 12 as well as for restricting their authority.

B. The media space for storing Virtual Receiver Transmitter Administrator, Virtual Knowledge Base Administrator and Virtual System Administrator and the media for storing up the Ids, passwords and authority of all users.

C. The media space for storing up Knowledge Working Sheet whose access approach follows the regulations of MBMS.

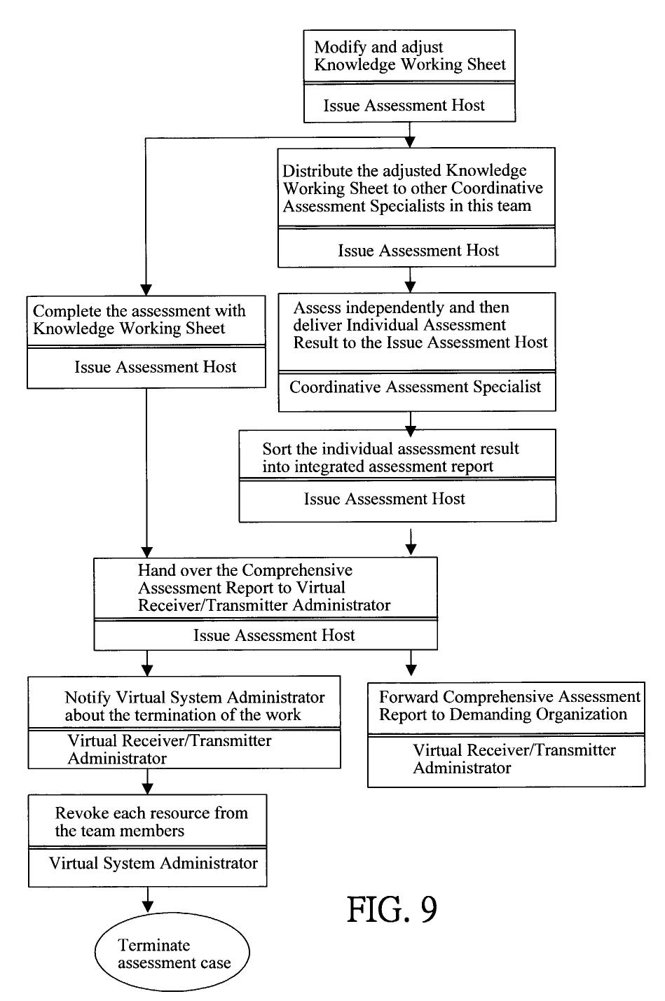

3. A Knowledge Application System 3 and the Server and browsing device connected to the system. The browsing device could be a common Browser or a custom-made system for several people to use this system independently and simultaneously without influencing one another (please refer to FIG. 4, FIG. 8 and FIG. 9). Knowledge Application System includes:

A. At least one Issue Assessment Host 31 (several Coordinative Assessment Specialists 32 are available if necessary) who shares Virtual Receiver Transmitter Administrator 21, Virtual System Administrator 22 and Virtual Knowledge Base Administrator 23 with other systems. When an issue in need of assessment appears, the Demanding Organization 01 issues the case notification to Virtual Receiver Transmitter Administrator 21 who notifies Virtual System Administrator 23 to form a certain group with all assessors involved, including one Issue Assessment Host 31 and/or several Coordinative Assessment Specialist 32, each one owning a particular temporary ID, password, authority and storage space. The duration of these items depends on the working hour of the case. Virtual Receiver Transmitter Administrator 21 delivers Assessment Working Sheet as the notification to the team members. After receiving the notification, Issue Assessment Host 31, according to the knowledge field of the issue, release (uploads) Knowledge Support Order to Virtual Receiver Transmitter Administrator 21. Then, Virtual Receiver Transmitter Administrator 21 forwards the order to Virtual Knowledge Base Administrator 22 who withdraws the knowledge list and knowledge application model from Knowledge Collection System 1 in light of the order's specification. The two resources are combined into Knowledge Working Sheet, which is then forwarded to Issue Assessment Host 31 through Virtual Receiver Transmitter Administrator 21. After receiving Knowledge Working Sheet, Issue Assessment Host 31 modifies and adjusts it adequately and makes assessment synthetically before handing the assessment report to Virtual Receiver Transmitter Administrator 21 who forwards the report to the Demanding Organization 01. Under the circumstances where the coordination of Coordinative Assessment Specialist 32 is available, Issue Assessment Host 31 should notify other Coordinative Assessment Specialists 32 with the modified and adjusted Knowledge Working Sheet as a start-up and require them to hand back the individual assessment results in the specified time. After receiving the assessment result of all Coordinative Assessment Specialists 32, it is the duty of Issue Assessment Host 31 to integrate, arrange and analyze them into Comprehensive Assessment Report and then hand it to Virtual Receiver Transmitter Administrator 21 who then forwards it to the Demanding Organization 01. In the meantime of forwarding the Comprehensive Assessment Report to the Demanding Unit 01, Virtual Receiver Transmitter Administrator 21 should notify Virtual System Administrator 23 for canceling the assessors' temporary working authority in this team. The assessment of the case is not completed until this step. What's more, Issue Assessment Host 31 mentioned in the previous item could also be the Demanding Unit.

During the process of assessment, in case of any serious conflicts emerging among each assessor, the host must coordinate appropriately and adjust the working sheet. Therefore, the system allows the procedure mentioned above to repeat time after time.

During the process of assessment, in case of running across any new discovery, Issue Assessment Host could add the items in the working sheet (such as the roles similar to Knowledge Research Specialist). Moreover, Issue Assessment Host must deliver the new items to Knowledge Base Administrator for filing, so as to flesh the knowledge base out.

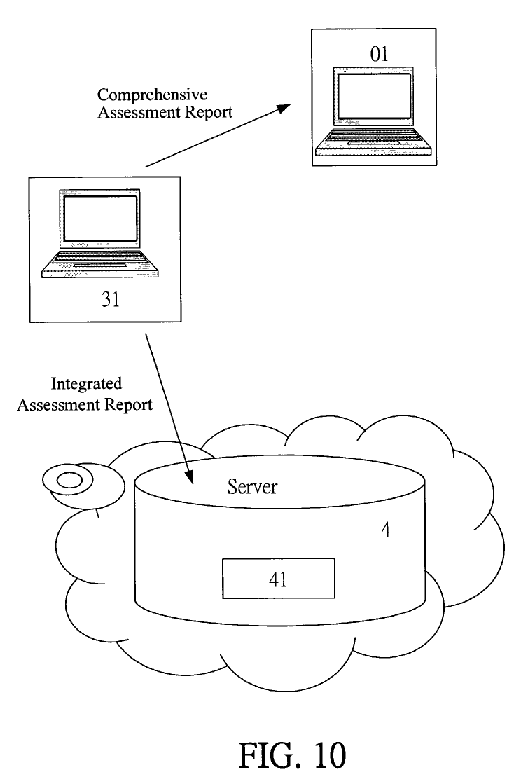

If the whole structure is equipped with Knowledge Case Inventory System 4 (please refer to FIG. 10), Virtual Receiver Transmitter Administrator must store up complete assessment report into the Case Base 41 to complete the whole assessment of the case.

B. More than one Case Coordinative Assessment Specialists 32 who start assessment on receiving Assessment Working Sheet and Knowledge Working Sheet and then store up the individual assessment result before handing it over Issue Assessment Host 31 through Internet. During the assessment, in case of running across any new discovery, each Coordinative Assessment Specialist could ask Issue Assessment Host to add the items in the working sheet (such as the role similar to Knowledge Research Specialist). Moreover, Issue Assessment Host must deliver the new items to Knowledge Base Administrator for filing, so as to flesh the knowledge base out.

The Server and browsing device include:

A. The storage space for the Ids, passwords, IPs, working authority and work-related data of Issue Assessment Host and Coordinative Assessment Specialists. The duration of the data depends on the working hour of the case. The browsing device could be voiced or digital wired or wireless communication equipment.

Please refer to FIG. 4. In addition to the above device and approach, one Knowledge Case Assessment Inventory System 4 and the Server connected to the case assessment system could be attached. Among which, Knowledge Case Assessment System stores up the quantified assessment result from the case assessment report and relative economic benefits in Case Base 41 for the case's future reference. The Server is the media space for storing cases and Case Base Management System.

Besides the above device and approach, one Knowledge Case Assessment Progress Track System and the Server connected to the case assessment system could be attached. With Virtual Receiver Transmitter Administrator as the controlling point, Knowledge Case Assessment Progress Trace System tracks the progress of the cases to understand the progress of each case. The Server is the media space for storing cases and Virtual Receiver Transmitter Administrator.

In comparison with the above citation and other traditional technology, the computer network-managing knowledge system permitting of a simultaneous, parallel and independent assessment approach and device for several people have the following advantages:

1. Through the accumulation, by sharing and expanding of knowledge, the present invention provides a decision-making model on the basis of knowledge and information, eliminating the “Flying-geese Effect” in conferences. Besides, the invention also helps proposing within the specified time, rather than making decision on the spot, achieving truly “universal” decision-making and enhances the quality of decision.

2. Participants involved in the decision-making distribute all over the world, unrestricted from time and space, and enhance the efficiency of decision-making.

3. In the meantime, the experience accumulation of the knowledge base shortens the time of learning and promotes the enterprise's competitiveness.

4. This present invention, through systematic collection, analysis, arrangement and application of relative information, accumulates the decision-maker's experience and obtains each kind of academic theory and the specialists' suggestions, which in turn extends the referral basis.

5. The present invention preserves the experience of each decision-making as the intellectual capital of the enterprise so as to protect the enterprise's competitiveness from the influence of personnel variation.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A computer network-managing knowledge system permitting of a simultaneous, parallel and independent assessment approach and device for several people used to assess value of issues and quality of products, congeal people's common consensus, achieve goals of decisions without being restricted by time and space of assessors, by means of said parallel operation, all coordinative assessors being able to comment independently, free from others' influence, said system collecting, symbolizing and textualizing knowledge content of abstract knowledge, subjective knowledge, human consciousness and business information systematically into Knowledge Base and Model Base, when a problem in need of a solution occurs, said system withdrawing adequate resources from Knowledge Base and Model Base for several people to express opinions simultaneously, equally and independently and obtaining quantified results through application of an analysis model for several people to operate together, concurrently and independently.

2. The computer network-managing knowledge system permitting of a simultaneous, parallel and independent assessment approach for several people of claim 1, wherein said approach includes following steps:
Step 1: Knowledge Research Specialist collects exposed knowledge and exploits concealed knowledge, Knowledge Base Management Specialist establishes Knowledge Base;
Step 2: Knowledge Analysis Specialist provides a knowledge analysis model and knowledge application model; then, Knowledge Base Management Specialist sets up a Model Base;
Step 3: Virtual Receiver Transmitter Administrator receives case notification from a Demanding Organization and issues notification to an assessment team, Virtual System Management dispatches necessary resources to said assessment team;
Step 4: Issue Assessment Host issues Knowledge Support Order to Virtual Knowledge Base Administrator through Virtual Receiver Transmitter Administrator;
Step 5: Virtual Knowledge Base Administrator integrates a knowledge list and corresponded analysis model into Knowledge Working Sheet, said Knowledge Working Sheet is then forwarded to Issue Assessment Host through Virtual Receiver Transmitter Administrator;
Step 6: Issue Assessment Host modifies and adjusts Knowledge Working Sheet to complete an assessment report; and
Step 7: Issue Assessment Host forwards said assessment report to said Demanding Organization through Virtual Receiver Transmitter Administrator, said Virtual Receiver Transmitter Administrator then notifies Virtual System Administrator to revoke each resource from said assessment team.

3. The computer network-managing knowledge system permitting of a simultaneous, parallel and independent assessment approach for several people of claim 1, wherein said approach includes following steps:
Step 1: After Knowledge Research Specialist collects exposed knowledge and exploits concealed knowledge, Knowledge Base Management Specialist establishes Knowledge Base;
Step 2: After Knowledge Analysis Specialist provides a knowledge analysis model and knowledge application model, Knowledge Base Management Specialist sets up Model Base;
Step 3: Virtual Receiver Transmitter Administrator receives case notification from a Demanding Organization and issues notification to an assessment team, Virtual System Management dispatches necessary resources to said assessment team;
Step 4: Issue Assessment Host issues Knowledge Support Order to Virtual Knowledge Base Administrator through Virtual Receiver Transmitter Administrator;
Step 5: Virtual Knowledge Base Administrator integrates a knowledge list and corresponded analysis model into Knowledge Working Sheet, said Knowledge Working Sheet is then forwarded to Issue Assessment Host through Virtual Receiver Transmitter Administrator;
Step 6: Issue Assessment Host modifies and adjusts Knowledge Working Sheet;
Step 7: Issue Assessment Host forwards a modified and adjusted Knowledge Working Sheet to Coordinative Assessment Specialists for individual assessment and then returns results back to Issue Assessment Host;
Step 8: Issue Assessment Host integrates assessment of his/hers and Coordinative Assessment Specialists into Comprehensive Assessment Report; and
Step 9: Issue Assessment Host forwards Comprehensive Assessment Report to Demanding Organization through Virtual Receiver Transmitter Administrator, said Virtual Receiver Transmitter Administrator then notifies Virtual System Administrator to revoke each resource from said assessment team.

4. A computer network-managing knowledge system permitting of a simultaneous, parallel and independent assessment device for several people, characterized in:
one Knowledge Collection System consisting of Knowledge Base and Model Base;
one Knowledge Supply System consisting of Virtual Receiver Transmitter Administrator, Virtual Knowledge Base Administrator and Virtual System Administrator;
one Knowledge Application System consisting of Issue Assessment Host and Coordinative Assessment Specialists; and
said Knowledge Supply System acting as a transmitting medium between Knowledge Collection System and Knowledge Application System to receive issues in need of assessment from Demanding Organization and then provide information from Knowledge Base and Model Base of Knowledge Collection System to Knowledge Application System, said Knowledge Application System then assesses said issue from said Demanding Organization with information and then returns an assessment report to said Demanding Organization through Knowledge Supply System.

5. The computer network-managing knowledge system permitting of a simultaneous, parallel and independent assessment device for several people of claim 4, wherein one Knowledge Case Assessment Inventory System can be attached to store up quantified assessment results from all case assessment reports and relative economic benefits in Case Base for future case reference.

6. The computer network-managing knowledge system permitting of a simultaneous, parallel and independent assessment device for several people of claim 4, wherein one Knowledge Case Assessment Progress Track System can be attached and with Virtual Receiver Transmitter Administrator as the controlling point, said Knowledge Case Assessment Progress Track System can track progresses of cases to understand a progress of each case.

7. The computer network-managing knowledge system permitting of a simultaneous, parallel and independent assessment device for several people of claim 4, wherein said Issue Assessment Host in Knowledge Application System can be a Demanding Organization.

8. The computer network-managing knowledge system permitting of a simultaneous, parallel and independent assessment device for several people of claim 4, wherein said Issue Assessment Host in Knowledge Application System should store new assessment knowledge in Knowledge Base of Knowledge Collection System to expand information of said Knowledge Base.
